(19) United States
(12) Patent Application Publication
(10) Pub. No.: US 2009/0172982 A1
(43) Pub. Date: Jul. 9, 2009

(54) Freestanding child on board indicator

(76) Inventor: David Heath Bell, Mento Park, CA (US)

Correspondence Address: James A. Gavney Jr.;JAG Patent Services LLC, Suite 21, 1901 Old Middlefield Way, Mountain View, CA, 94043, US

(21) Appl. No.: 12/319,391

(22) Filed: Jan. 6, 2009

Related U.S. Application Data
(60) Provisional application No. 61/010,665, filed on Jan. 9, 2008.

(51) Int. Cl. G09F 13/00; G09F 19/00

(52) U.S. Cl. 40/541; 40/606.01

(57) ABSTRACT

A free-standing on-board safety device is disclosed. The free-standing on-board safety includes a base portion and a head portion coupled through a tapered body. The head portion is preferably substantially round and brightly colored. In use the free-standing on-board safety device is placed on front seat of the passenger vehicle in an up-right vertical position. In the up-right vertical position, the device is visible to a driver of the passenger vehicle and the head portion is visible to persons outside of the vehicle through one or more windows of the passenger vehicle. When placed in the up-right vertical position, the free-standing on-board safety device indicates the presence of a child, infant or pet in a back seat of the passenger vehicle.

### RELATED APPLICATION

This Application claims priority under 35 U.S.C. §119(e) from the U.S. Provisional Patent Application Ser. No. 61/010,665, filed on Jan. 9, 2007, and titled FREESTANDING CHILD ON BOARD INDICATOR.” The co-pending U.S. Provisional Patent Application Ser. No. 61/010,665, filed on Jan. 9, 2007, and titled FREESTANDING CHILD ON BOARD INDICATOR” is hereby incorporated by reference.

### FIELD OF THE INVENTION

This invention relates generally to passenger vehicle safety equipment. More specifically, this invention relates to a device that free stands within an automobile to provide an indication that a child, infant or pet is currently within the passenger vehicle.

### BACKGROUND OF THE INVENTION

In the area of auto safety, indicators that a child, an infant or a pet is within the car can enhance the safety and comfort of a child. A child may be sleeping within the vehicle and such an indicator would provide warning to minimize the amount of noise generated. Additionally, incidences have occurred were a child, an infant or a pet is left in a vehicle. A visible indicator would provide a reminder of the child, the infant or the pet is in the vehicle and prevent exposure to excessive heat. Bumper stickers have been used to indicate that a child, an infant or a pet is within the vehicle and that care should be taken around the vehicle. Bumper stickers have the problem that they are usually only visible from one direction unless multiple stickers are applied to all sides of a vehicle.

Further, bumper stickers indicating that there is a child, an infant or a pet on-board the passenger vehicle do not always attract the attention of other drivers because of the number of other types of bumper stickers with different messages. Another problem with bumper stickers is that they are not easily removable and thus people tend to disregard them.

What is needed is a safety device for providing an indication that a child, an infant or a pet is on-board that is viewable from multiple directions, is easily recognizable, and is removable from the vehicle when there is no child, infant, or pet within the vehicle.

### SUMMARY OF THE INVENTION

On the list of “every parent's worst nightmare,” is an accident that is now occurring with increasing frequency. The sleeping or quiet child in the back seat of a light vehicle (includes automobiles, mini-vans, utility vehicles, and light trucks) gets left behind as the driver departs, only to be found dead or seriously injured hours later due to hypothermia (the temperature inside a stopped car can increase by as much as 50° F. within 40 minutes).

Today's drivers are more preoccupied than ever before, and the trend towards busier minds and lifestyles is only increasing every day. As ABC's Good Morning America conveyed on Jul. 20, 2008; “Exhausted and distracted working parents can simply forget to drop their child at daycare and go straight to work. They grab their purse or briefcase off the passenger's seat and head in to work, never realizing that they have a quiet or sleeping child in the back seat.”

The optimal solution to this problem is to provide a product that triggers a modification in the driver's behavior every time that he or she gets into a vehicle with a baby or child. To succeed at this behavioral modification, the safety device of the present invention is provided to be a purpose-built, freestanding, in-vehicle, ultra-lightweight device which is intended to be located in one of two areas in the vehicle, based on the presence and location of the child. In addition to creating a virtual child “extension” adjacent to the driver as a constant reminder, the free-standing safety device of the present invention is tall enough to create a fail-safe notice to any passer-by when the car is parked that a child may be in the back seat.

The safety device of the present invention includes a body with a base portion having a bottom surface. The width or diameter of the bottom surface is preferably between 5 to 9 inches. The device further includes a head portion coupled to the body. The head portion is preferably substantially round and brightly colored. For example, the head portion is yellow neon with a smiling face displayed thereon. Also, the head portion preferably has a width or diameter of between 2 to 6 inches.

The safety device of the present invention is formed from one or more foam materials or plastic materials. The safety device, or a portion thereof, is solid or, alternatively, is configured to be inflatable. In accordance with further embodiments of the invention the safety device of the present invention includes a sleeve, is configured to be extendable and/or includes one or more sensors and/or lighting features, such as described below. Preferably, a top surface of the head portion and the bottom surface of the base portion are separated by a distance between 20 and 26 inches.

In accordance with yet further embodiments of the invention, the body, the base portion and/or edges of the bottom surface are patterned or contoured with flattened surfaces to prevent the safety device from rolling while lying down in a horizontal position on a seat or floor of a passenger vehicle. The safety device of the present invention is described below as a safety device for indication of the presence of a child or infant. However, it is understood that the safety device of the present invention can also be used to indicate the presence of a pet or pets.

In operation the safety device of the present invention is placed in an up-right vertical position on a front seat of the passenger vehicle when a child or an infant is placed in the baby seat. While standing in the up-right vertical position in the front passenger seat of the vehicle, the safety device of the present invention is always in the peripheral vision of a driver and a bright colored head portion of the device is visible to any passers-by when otherwise a child might easily be hidden by the protective child car seat, rear-seat limited visibility, or tinted rear glass. When the child or infant is not present, the safety device of the present invention is sitting in the car seat, or is placed adjacent to the car seat, lying on its side in the horizontal position on the passenger seat, or is placed in a sitting position on a floor of the passenger vehicle.

The device of the present invention is an “active alert symbol” and is distinguished from many passive products, such as “Baby on Board” stickers, which are in place 24×7 and only serve as a plea to other drivers to drive carefully. The safety device of the present invention is intentionally Not a Toy, as toys will easily be used for other purposes and the vehicle driver will not maintain safety as the priority for this product.

### BRIEF DESCRIPTION OF THE DRAWINGS

FIG. 1 illustrates a safety device with the preferred dimensions, in accordance with the embodiments of the invention.

FIG. 2 shows a safety device positioned on a front seat of a passenger vehicle, in accordance with a preferred method of the invention.

FIGS. 3A-B show a safety device with a preferred design, in accordance with the embodiments of the present invention.

### DETAILED DESCRIPTION OF THE INVENTION

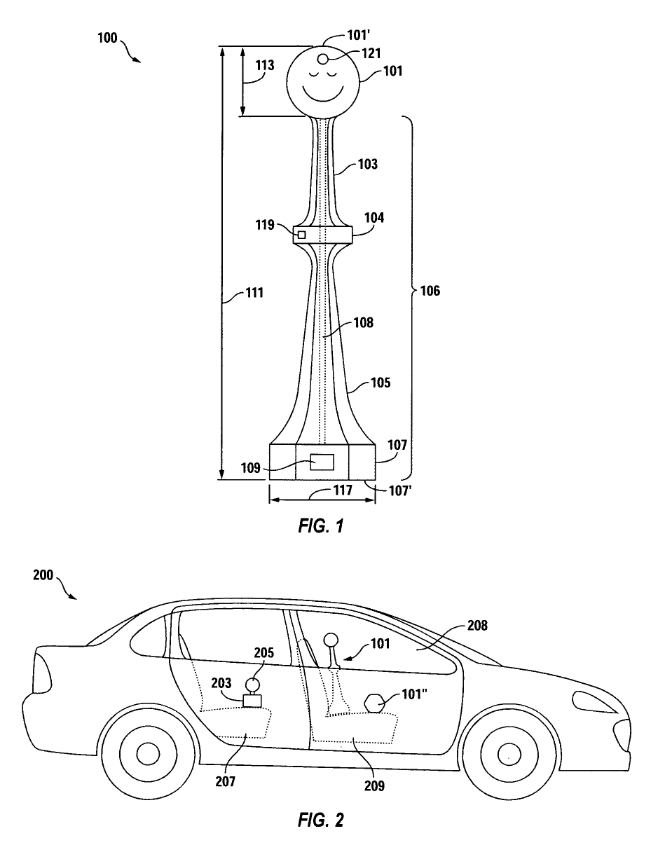

The present invention is directed to a portable free-standing on-board safety device, hereafter referred to as a safety device. The safety device of the present invention provides a visual indication to a driver of a passenger vehicle and persons outside of the passenger vehicle that a child or an infant is currently in the back seat of the passenger vehicle. FIG. 1 illustrates a safety device 100 with the preferred dimensions, in accordance with the embodiments of the invention.

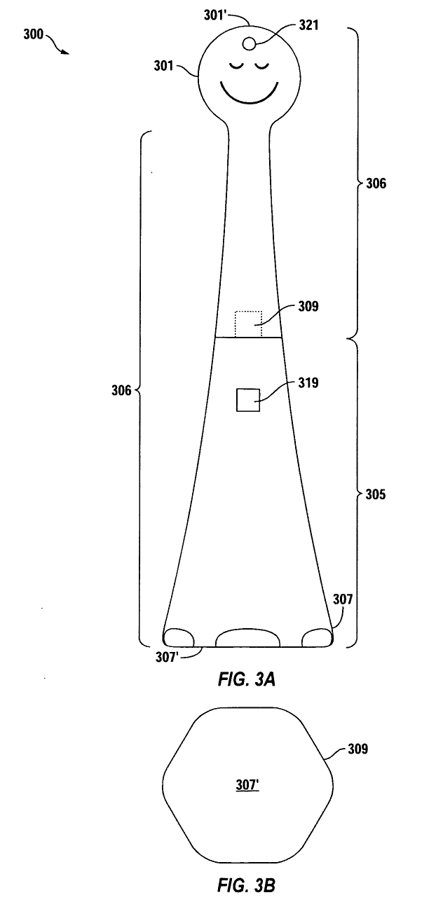

The safety device 100 of the present invention is formed from one or more foam material or plastic material. The safety device, or a portion thereof, is solid or, alternatively, is configured to be inflatable. In a preferred embodiment of the invention, a safety device 300 made from a two-part foam structure, such as described below with reference to FIG. 3. Regardless of the material or materials used to make the safety device of the present invention, the weight distribution of the safety device is such that the safety device will remain in an up-right vertical position even when the passenger vehicle accelerates or migrates through turns.

The safety device of the present invention includes a head portion 101 that is coupled to a body 106. The body 106 has a base portion 107 with a bottom surface 107′ and one or more neck portions 103 and 105. The bottom surface 107′ preferably has a width that is between 5 to 9 inches, more preferably between 6 to 8 inches and most preferably between 6.5 and 7.5 inches, such as indicated by the arrow 117. Regardless of the width or diameter of the bottom surface 107′, the bottom surface 107′ is configured to be placed on a seat of a passenger vehicle 209 (FIG. 2) with the safety device 100 in an up-right vertical position.

Still referring to FIG. 1, the head portion 101 is preferably substantially round and brightly colored. For example, the head portion 101 is yellow neon with a smiling face displayed thereon. Also, the head portion 101 preferably has a width or diameter that is between 2 to 6 inches, more preferably between 3 to 5 inches and most preferably between 3.5 to 4.5 inches, such as indicated by the arrow 113. Regardless of the width or diameter of the head portion, a top surface 101 of the head portion 101 and the bottom surface 107′ of the base portion 107 are preferably separated by a distance between 20 and 26 inches, more preferably between 21 to 25 inches and most preferably between 22-24 inches. This helps to ensure that the head portion 101 of the device is visible through one or more windows of most commercially available passenger vehicles while the safety device 100 is in the up-right vertical position.

In accordance with yet further embodiments of the invention, the body 106, the base portion 107 and/or edges of the bottom surface 107′ are patterned or contoured with flattened surfaces to prevent the safety device 100 from rolling while lying down in a horizontal position on a seat or floor of a passenger vehicle. The body 106 of the safety device 100 in further embodiments of the invention includes a collar structure 104 to stabilize the safety device 100 in a horizontal position 101″ (FIG. 2) and or a weighted feature 109 to stabilize the safety device 100 in the vertical position 101 (FIG. 2). The safety device 100 in further embodiments of the invention includes a rod or stabilizing feature 108 to provide structural integrity to the safety device 100.

FIG. 2 shows a safety device 101 positioned on a front seat 209 of a passenger vehicle 200, in accordance with the method of the invention. In operation the safety device 101 of the present invention is placed in an up-right vertical position on the front seat 209 of the passenger vehicle 200 when a child or an infant 205 is present or placed in a car seat 203 on a back seat 207 of the passenger vehicle 207. While standing in the up-right vertical position on the front passenger seat 209 of the passenger vehicle 200, the safety device 101 of the present invention is always in the peripheral vision of the driver (not shown) and the head portion 100 is visible to other persons outside of the passenger vehicles 200. When the child or the infant is not present or removed for the car seat 203, the safety device 101 of the present invention is placed in the car seat 203 or is placed in an adjacent to the baby seat, lying on its side in the horizontal position on the front passenger seat 209, as indicated by 101′ or, alternatively is placed in a sitting position on a floor of the passenger vehicle 200.

The safety device 101 of the present invention can also be used as a flotation device in emergency situation and/or can be used as an indicator that road-side assistance is required when placed outside of a stranded passenger vehicles. Further, the safety device 100 of the present invention can be used to provide road-side visibility when fixing the stranded passenger vehicle. For example, when changing a tire on the stranded passenger vehicle, the safety device 100 is placed next to the person changing the tire to provide road-side visibility for other drivers passing by.

In still further embodiments of the invention the safety device 100 includes a sleeve and/or is configured to be extendable, such that the distance between the top surface 101′ of the head portion 101 and the bottom surface 107′ of the base portion 107 is adjustable through, for example, a telescoping mechanism (not shown). The safety device can include one or more sensors 119 or lighting features 121 that are actuated automatically or manually. For example, the safely device 100 includes a heat sensor 119 that automatically actuates a lighting feature 121 in the head portion 101 when the temperature inside of the passenger vehicles 200 becomes unsafe for the child or the infant 205 present in the car seat 203.

In accordance with a preferred design of the present invention a safety device 300 is formed from a top section 306 and bottom section 305, each made from a resilient closed cell foam material. In accordance with the embodiments of the invention the top section 306 is formed from a first foam material and bottom section 305 is formed from a second foam material that is different from the first foam material. For example, the second foam material is denser than the first foam material providing additional weight and helping to stabilize the safety device 300 in the up-right vertical position when the passenger vehicle accelerates or migrates through turns.

The top section 306 and the bottom section 305 are coupled together through a dowel feature which is attached to the top portion 306 or the bottom portion 305 and which fits into a matched aperture feature on the other of the top section 306 and bottom section 305. The top section 306 and the bottom section 305 are glued together or otherwise securely attached together to form a tapered body 306 with a base portion 307 having a bottom surface 307′ and a head portion 301 with a top surface 301′. Referring to FIG. 3B, in accordance with the preferred embodiment of the invention, edges 309 of the bottom surface 307′ are patterned with flattened surfaces to prevent the safety device 300 from rolling while lying down in a horizontal position on a seat or floor of a passenger vehicle.

Referring now to FIGS. 3A-B, the bottom surface 307′ of the safety device 300 preferably has a width that is between 5 to 9 inches, more preferably between 6 to 8 inches and most preferably between 6.5 and 7.5 inches; the head portion 301 of the safety device 300 preferably has a width or diameter that is between 2 to 6 inches, more preferably between 3 to 5 inches and most preferably between 3.5 to 4.5 inches; and the top surface 101′ of the head portion 101 and the bottom surface 107′ of the base portion 107 are preferably separated by a distance between 20 and 26 inches, more preferably between 21 to 25 inches and most preferably between 22-24 inches. As described previously, the safety device 300 in accordance with the embodiments of the invention includes one or more sensors 319 or lighting features 321 that are actuated automatically or manually.

The present invention has been described in terms of specific embodiments incorporating details to facilitate the understanding of the principles of construction and operation of the invention. As such, references herein to specific embodiments and details thereof are not intended to limit the scope of the claims appended hereto. It will be apparent to those skilled in the art that modifications can be made in the embodiments chosen for illustration without departing from the spirit and scope of the invention.

What is claimed is:

1. A safety device indicating that a child or pet is within a passenger vehicle, the safety device comprising:
a) a body with a base portion having a bottom surface configured to sit on front seat of the passenger vehicle with the safety device in an up-right vertical position; and
b) a head portion with a top surface, the head portion being coupled to the body and being brightly colored and visible through a passenger-side window of the passenger vehicle with the device in the up-right vertical position.

2. The safety device of claim 1, wherein the body tapers from the base portion to the head portion.

3. The safety device of claim 2, wherein the body and the head portion are formed from a foam material.

4. The safety device of claim 2, wherein at least a portion of the body and the head portion are inflatable.

5. The safety device of claim 1, wherein the base portion of the body is weighted or denser that than the head portion.

6. The safety device of claim 1, wherein the head portion is yellow neon, substantially round and has a diameter between 2 to 6 inches.

7. The safety device of claim 5, where the top surface of the head portion and the bottom surface of the base portion are separated by a distance between 20 and 26 inches.

8. The safety device of claim 6, the distance between the surface of the head portion and the bottom surface of the base portion is adjustable.

9. The safety device of claim 7, wherein the bottom surface of the base portion has a width between 5 to 9 inches.

10. The safety device of claim 8, wherein the bottom surface of the base portion is scalloped or contoured to prevent the safety device from rolling while lying down in a horizontal position on the seat of the passenger vehicle.

11. A safety device indicating that a child or pet is within a passenger vehicle, the safety device comprising:
a) a body with a base portion having a bottom surface configured to sit on front seat of the passenger vehicle with the safety device in an up-right vertical position; and
b) a head portion with a top surface, the head portion being coupled to the body and being brightly colored and visible through a passenger-side window of the passenger vehicle with the safety device in the up-right vertical position, wherein the base portion has a width or diameter between 5 to 9 inches, the head portion has a width or diameter that is between 2 to 6 inches and the top surface bottom surface are separated by a distance between 20 and 26 inches.

12. The safety device of claim 11, wherein the body tapers from the base portion to the head portion.

13. The safety device of claim 11, wherein the safety device is formed from a two-part foam structure comprising a top section with the head portion and bottom section comprising the base portion.

14. The safety device of claim 13, wherein the top section is formed from a first material and the bottom section is formed from a second material that is different from the first material.

15. The safety device of claim 11, further comprising one or more sensor.

16. The safety device of claim 11, further comprising one or more lighted features.

17. The safety device of claim 11, wherein the edges of the bottom section have flattened surfaces to prevent the safety device from rolling while lying down in a vertical position on the seat of the passenger vehicle.

18. A method of making a safety device comprising;
a) forming a top section with a rounded head portion;
b) forming a bottom section comprising the base portion; and
c) coupling the top section and the bottom section together to form the safety device with a body that tapers from the base portion to the head portion.

19. The method of claim 18, wherein the edges of the bottom section have flattened surfaces to prevent the safety device from rolling while lying down in a vertical position on the seat of the passenger vehicle.

20. The method of claim 18, the top section and the bottom section are formed from one or more foam materials.

21. The method of claim 18, wherein the base portion has a width or diameter between 5 to 9 inches, the head portion has a width or diameter that is between 2 to 6 inches and a distance from the top surface to the bottom surface is between 20 and 26 inches.
